(19) United States
(12) Patent Application Publication
(10) Pub. No.: US 2007/0216531 A1
(43) Pub. Date: Sep. 20, 2007

(54) Rfid Sensor and Ubiquitous Sensor Network System Thereof

(76) Inventor: Kun-Hong Lee, Seoul (KR)

Correspondence Address: VENABLE LLP, P.O. BOX 34385, WASHINGTON, DC, 20043-9998, US

(21) Appl. No.: 11/547,751

(22) PCT Filed: Apr. 7, 2005
(86) PCT No.: PCT/KR05/01000

§ 371 Date: Oct. 6, 2006

(30) Foreign Application Priority Data
Apr. 7, 2004 (KR) 10-2004-0023882

(51) Int. Cl. G08B 13/14

(52) U.S. Cl. 340/572.1; 340/10.1

(57) ABSTRACT

The present invention relates to a Radio Frequency Identification (RFID) sensor using an RFID tag and a ubiquitous sensor network system using the RFID sensor. The RFID sensor extracts a unique number of at least one RFID chip chosen according to a used state of a monitored object among at least one chip set up on a monitored object according to the number of usable states of the monitored object. A controlling unit receives the unique number from the RFID sensor and recognizes the used state of the monitored object on the basis of meaning information of the unique number. The present invention provides an effect to embody a sensor that can be set up easily by using an RFID tag in a low price. Also, the present invention provides another effect that all kinds of objects can be monitored easily in a low price by using an RFID tag without a wire and a power supply.

### TECHNICAL FIELD

The present invention relates to a Radio Frequency Identification (RFID) sensor and a ubiquitous sensor network system thereof; and, more particularly, to an RFID sensor using an RFID tag and a ubiquitous sensor network system using the RFID sensor.

### BACKGROUND ART

At present, the amount of electricity, service water and a gas used in each home or building is measured by a meter such as a gas measure, a gasometer or a water meter, and conventionally a meterman under each supervising post checks with the naked eye the used amount at regular intervals in each home. However, the method checking a meter by a meterman requires a lot of manpower and time. In particular, in cases that the meter is positioned in a place where it is too difficult for the meterman to access the meter or a user of each home is absent when the meterman visits, it is very difficult to inspect the meter.

To solve the problems, a remote meter inspection technology using a leased line or a telephone line has been developed recently. Also, a remote meter inspection technology that a used state of the meter is checked and transmitted wirelessly has been developed.

However, a remote inspection system by a wire or wireless method should have sensors for sensing a used state of a meter separately. The sensors are expensive, and particularly the sensor by a wireless method is more expensive, in addition, since an operation power line and a signal line need to be installed when the sensor is set up, it is not easy to set up the sensor and a cost for setting up sensor is high.

Meanwhile, as soon as a crime prevention system senses a trespass on another's premises and generates a warning sound, it transmits sensed information to a crime prevention service provider or a police office by the wire or wireless method. In the crime prevention system, the sensor is set up in each monitoring position such as a door or a window and senses whether there are any unusual things or not in the monitoring position. The sensor of the crime prevention system is expensive like the sensor of the remote inspection system, and since the operation power line and the signal line need to be installed when the sensor is set up, it is not easy to set up the sensor and a cost for setting up the sensor is high. Also, in other monitoring systems besides the remote inspection system or the crime prevention system, the operation power line and the signal line need to be installed when the expensive sensor is set up, and it is not easy to set up the sensor and a cost for setting up the sensor is high.

### DISCLOSURE

Technical Problem

It is, therefore, an object of the present invention to provide a Radio Frequency Identification (RFID) sensor using an RFID tag without a wire and a power supply.

It is, therefore, another object of the present invention to provide a ubiquitous sensor network system that can monitor all kinds of objects easily in a low price through an RFID sensor using an RFID tag without a wire and a power supply.

Technical Solution

In accordance with one aspect of the present invention, there is provided a ubiquitous sensor network system including a Radio Frequency Identification (RFID) sensor and a controlling unit. The RFID sensor extracts a unique number of at least one RFID chip chosen according to a used state of a monitored object among at least one chip set up on a monitored object according to the number of usable states of the monitored object. A controlling unit receives the unique number from the RFID sensor and recognizes the used state of the monitored object on the basis of meaning information of the unique number.

Preferably, the present invention further includes a naming center for storing manufacturer information of the unique number of the RFID chip and a database server for storing meaning information of the unique number for each manufacturer. Herein, the controlling unit requests manufacturer information of the unique number of the chosen RFID chip to the naming center and receives the manufacture information, then requests the meaning information of the unique number of the chosen RFID chip to the database server on the basis of the received manufacturer information and receives the meaning information. Subsequently, the controlling unit recognizes the used state of the monitored object on the basis of the received meaning information. The received meaning information can be stored in the controlling unit, and acquired from the controlling unit afterward.

Preferably, the controlling unit transmits the used state information of the monitored object to the external service system center through a communication network. The controlling unit transmits the used state information of the monitored object to the mobile phone service provider through a communication network. The mobile phone service provider transmits a warning message to a user's mobile phone terminal on the basis of the used state information. The controlling unit transmits the warning message directly to a user's terminal.

The present invention as an RFID sensor includes at least one RFID chip set up on a monitored object according to the number of usable states of the monitored object, an RFID antenna for receiving a radio frequency signal from a RFID reader, and a selection unit for choosing one of the RFID chip and connecting the chosen RFID chip to the RFID antenna. The RFID antenna transmits the unique number of the chosen RFID chip to the RFID reader

The present invention as an RFID sensor includes a plurality of RFID chips set up on a monitored object according to the number of usable states of the monitored object, a plurality of RFID antennas of the same number with the RFID chips, each one of the RFID antennas corresponding to one of the RFID chips respectively, the RFID antennas receiving a radio frequency signal from a RFID reader, and a selection unit for choosing at least one of the RFID chips and connecting the chosen RFID chip to the corresponding RFID antenna respectively. The RFID antenna transmits the unique number of the chosen RFID chip to the RFID reader.

The present invention as an RFID sensor includes at least one RFID chip set up on a monitored object according to the number of usable states of the monitored object, at least one RFID antenna receiving a radio frequency from an RFID reader and connected to the RFID chip respectively, and a blackout plate for shielding the RFID antenna selectively. The RFID antenna, which is not shielded, transmits the unique number of the connected RFID chip to the RFID reader.

Other objects and aspects of the invention will become apparent from the following description of the embodiments with reference to the accompanying drawings, therefore, those skilled in the art that the present invention pertains to can embody the technology concept and scope of the invention easily. In addition, if it is considered that detailed description on the prior art blur the point of the present invention, the detailed description will not be provided herein.

Advantageous Effects

The present invention provides an effect to embody a sensor that can be set up easily by using an RFID tag in a low price. Also, the present invention provides another effect that all kinds of objects can be monitored easily in a low price by using an RFID tag without a wire and a power supply.

### DESCRIPTION OF THE DRAWINGS

The above and other objects and features of the present invention will become apparent from the following description of the preferred embodiments given in conjunction with the accompanying drawings, in which:

FIG. 1 is a block diagram showing a ubiquitous sensor network system using a Radio Frequency Identification (RFID) sensor according to an embodiment of the present invention;

FIG. 2 is a block diagram showing a ubiquitous sensor network system for monitoring a used state of the gas valve in accordance with an embodiment of the present invention;

FIG. 3 is a block diagram showing a ubiquitous sensor network system for sensing a used state of a gasometer in accordance with an embodiment of the present invention;

FIG. 4 is a block diagram showing a ubiquitous sensor network system for monitoring a used state of a door in accordance with an embodiment of the present invention;

FIG. 5 is a block diagram showing an RFID sensor in accordance with one embodiment of the present invention;

FIG. 6 is a diagram showing a ubiquitous sensor network system for sensing a used state of a window; and

FIG. 7 is a schematic block diagram showing a ubiquitous sensor network system in accordance with one embodiment of the present invention.

### BEST MODE FOR THE INVENTION

Other objects and aspects of the invention will become apparent from the following description of the embodiments with reference to the accompanying drawings, which is set forth hereinafter.

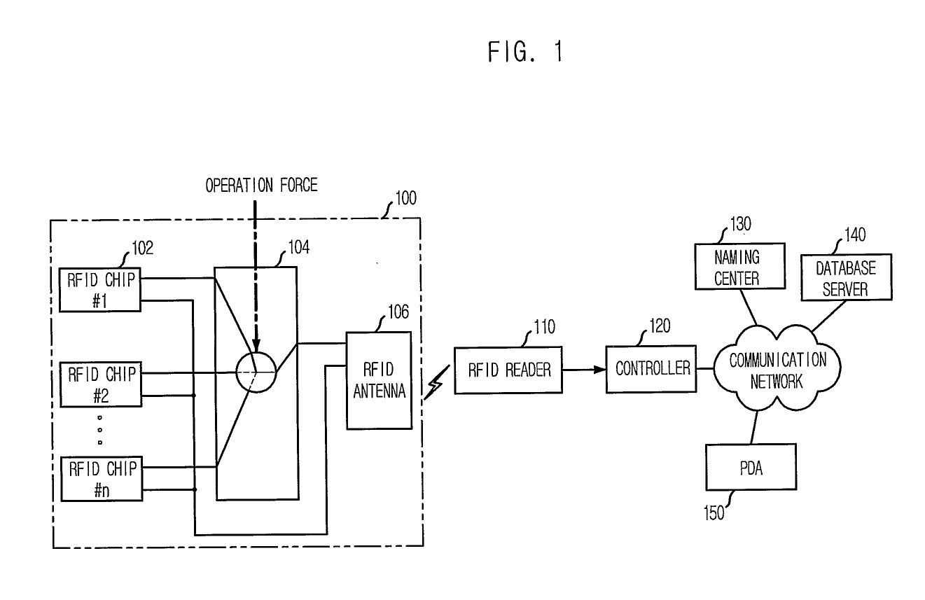

FIG. 1 is a block diagram showing a ubiquitous sensor network system using a Radio Frequency Identification (RFID) sensor according to the embodiment of the present invention. The ubiquitous sensor network system includes an RFID sensor 100, an RFID reader 110 and a controller 120.

The RFID sensor 100 provides with a plurality of RFID chips 102 which are set up according to the number of usable states of the monitored object, and chooses a pertinent RFID chip 102 according to the used state of the monitored object. Then the RFID sensor 100 transmits a unique number of the chosen RFID chip to the RFID reader 110 through an antenna 106. The RFID sensor 100 can be manufactured as one body with the monitored object when the monitored object is produced.

The monitored object includes any kind of thing of which the used state needs to be monitored, such as a gas valve, a door, a floor tile, a window and a meter. For example, the gas valve and the door have two usable states such as an open state and a closed state. The floor tile has two usable states according to the presence of pressurization. The window can have more than two usable states if a degree of openness is checked. The meter in four figures has ten usable states for each one of four number indicators.

The RFID chips as many as the number of usable states of the monitored object are set up, but it is possible to set up the RFID chips less than the number of the usable states. For example, One RFID chip can be used to check the used state of the gas valve.

The RFID reader 110 has a similar configuration to the conventional RFID system reader. The RFID reader 110 transmits a radio frequency signal to the RFID sensor 100 at a predetermined period, and receives a frequency signal having the unique number of the chosen RFID chip from the RFID sensor 100. Then the RFID reader 110 transmits the signal having the unique number to the controller 120. Of course, the function of the RFID reader 110 can be performed in the controller 120.

The controller 120 checks the used state of the monitored object by checking the unique number of the chosen RFID chip. The controller 120 requests manufacturer information of the unique number of the RFID chip to a naming center 130 storing a source of the unique number of the RFID chip. The naming center 130 possesses manufacturer information with reference to the unique number of the RFID chip, searches the manufacturer information according to the requests of the controller 120, and provides the manufacturer information to the controller 120.

The controller 120 receives the manufacturer information from the naming center 130 and requests the meaning of the unique number to a database server 140 of the manufacturer. The database server 140 can be managed by each manufacturer separately. The database server 140 stores meaning information of each unique number, searches the meaning information according to the requests of the controller 120, and provides the information to the controller 120. For example, a database server 140 provides “The gas valve of A's house is open” information to the controller 120 according to the requests of the controller 120. The controller 120 can provides the “The gas valve is open” information to the user through a Personal Digital Assistance (PDA) 150. It will be apparent to those skilled in the art that the naming center 130 and the database server 140 can be integrated into one device.

The meaning information of the RFID chip obtained from the naming center 130 and the database server 140 is stored in the controller 120 and can be obtained directly from the controller 120 without requesting to the naming center 130 and the database server 140.

As described above, the RFID sensor 100 including a RFID chip having simply a unique number becomes a ubiquitous sensor having a specific meaning at any time and any place, by referring to the information of the naming center 130 and the database server 140.

Describing in detail a composition of the RFID sensor 100 referring to FIG. 1, the sensor 100 includes RFID chips 102, a selection unit 104 and an RFID antenna 106. The RFID chips 102 are set up separately according to the number of usable states of the monitored object and have unique identification numbers. The selection unit 104 chooses one of RFID chips 102 by a physical or an electrical operation, or a physical variance of the monitored object and connects the chosen chip to the RFID antenna 106. The RFID antenna 106 receives the radio frequency signal from the RFID reader 110 and transmits the unique number of the chosen RFID chip of the RFID chips 102 to the RFID reader 110 wirelessly.

In FIG. 1, the selection unit 104 connects the plural RFID chips 102 to one RFID antenna 106 selectively, but in other cases, the selection unit 104 can connect a plurality of RFID chips to a plurality of RIFD antennas corresponding to the respective RFID chips selectively.

The embodiment of the ubiquitous sensor network system in accordance with the present invention will be described in detail hereinafter.

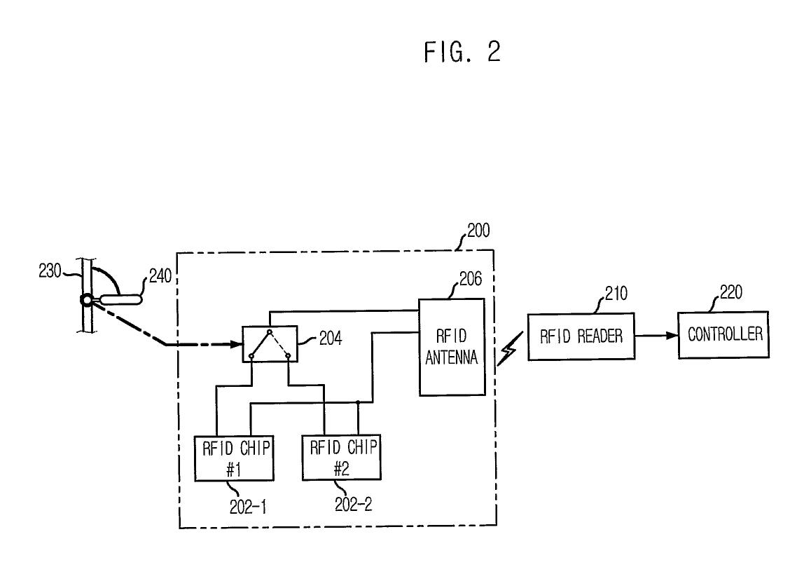

FIG. 2 is a block diagram showing a ubiquitous sensor network system for monitoring the used state of the gas valve in accordance with one embodiment of the present invention.

The RFID sensor 200 senses the used state of the gas valve 240 which is set up in a gas pipe 230. The RFID sensor 200 includes two RFID chips 202-1 and 202-2 outputting signals of a closed state and an open state of the gas valve 240 respectively, a selection unit 204 and an RFID antenna 206. The first RFID chip 202-1 and the second RFID chip 202-2 are connected to a closed position and an open position of the selection unit 204 respectively. The selection unit 204 includes a rotary switch working by the physical operation force caused by the opening and closing of the gas valve, and connects one chosen chip of the first RFID chip 202-1 and the second RFID chip 202-2 to the RFID antenna 206.

The RFID antenna 206 receives a wireless signal generated from the RFID reader 210 and transmits a unique number of the chosen RFID chip of the first RFID chip 202-1 and the second RFID chip 202-2 to the RFID reader 210 wirelessly.

As shown in FIG. 2, in case that the gas valve 240 is closed, the first RFID chip 202-1 is connected to the RFID antenna 206. If the RFID reader 210 outputs the radio frequency signal for checking the state of the gas valve 240 to the RFID antenna 206 periodically, the unique number of the first RFID chip 202-1 is transmitted to the RFID reader 210 through the RFID antenna 206. The RFID reader 210 receives a unique number of the first RFID chip 202-1 and transmits the number to a controller 220.

The controller 220 has information that the unique number of the first RFID chip 202-1 means that the gas valve 240 is closed and the unique number of the second RFID chip 202-2 means that the gas valve 240 is open. The information can be obtained through the naming center 130 and the database server 140. The controller 220 can recognize the gas valve 240 in a closed state by checking the received unique number of the first RFID chip 202-1.

In the same way, in case that the gas valve 240 is open, the second RFID chip 202-2 is connected to the RFID antenna 206. If the RFID reader 210 outputs the radio frequency signal for checking the state of the gas valve 240 to the RFID antenna 206 periodically, the unique number of the second RFID chip 202-2 is transmitted to the RFID reader 210 through the RFID antenna 206. The RFID reader 210 receives the unique number of the second RFID chip 202- 1 and transmits the number to the controller 220. The controller 220 can recognize the gas valve 240 is in a open state by checking the received unique number of the second RFID chip 202-2.

In FIG. 2, two RFID tags are used to sense two used states, that is, an open state and a closed state of the gas valve 240. However, it is possible to recognize whether the gas valve 240 is open or closed by using only one RFID chip. In other words, a used state of a monitored object having two usable states can be determined by checking whether one RFID chip is selected or not and whether there is a transmitted signal from the RFID chip.

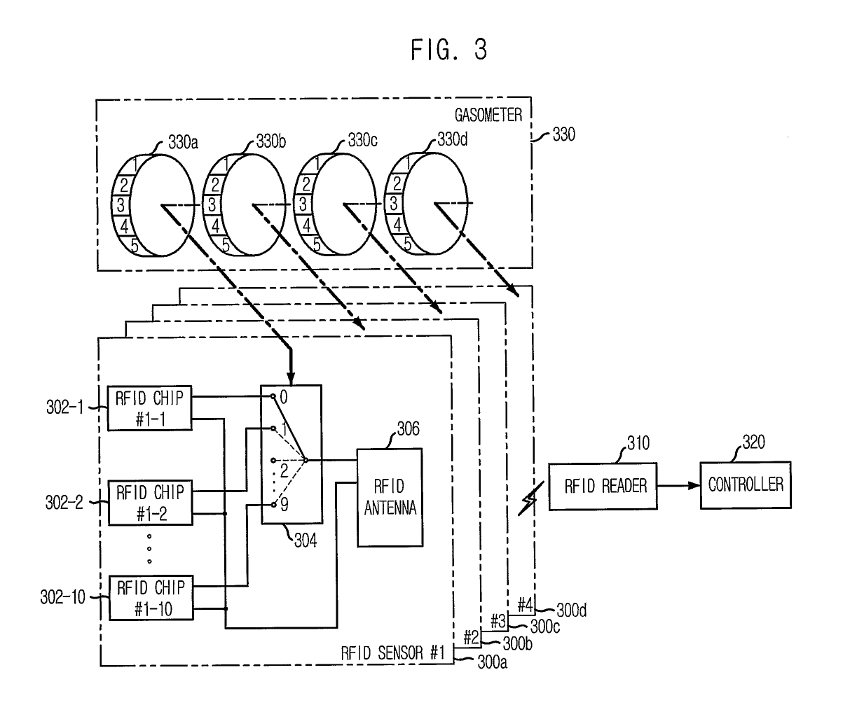

FIG. 3 is a block diagram showing a ubiquitous sensor network system for sensing a used state of a gasometer in accordance with one embodiment of the present invention.

The RFID sensors 300a, b, c and d sense an inspected state of the gasometer 330. The gasometer has four rotary number indicators 330a, 330b, 330c and 330d. The RFID sensors 300a, b, c and d for sensing a value of the inspected state are set up on the rotary number indicators 300a, 300b, 300c and 330d. Since each sensor and indicator has the same composition and operation, the RFID sensor 300a with respect to the first rotary number indicator will be described representatively.

The first RFID sensor 300a includes ten RFID chips 302-1 to 302-10 set up to correspond to ten digits from 0 to 9 of the first rotary number indicator 300a, a selection unit 304, and an RFID antenna 306. The selection unit 304 includes a switch working by a physical operation force caused by the rotation of the first rotary number indicator 300a and connects a chosen chip of ten RFID chips 302-1 to 302-10 to the RFID antenna 306.

The RFID antenna 306 receives the wireless signal generated from the reader 310 and transmits a unique number of the chosen RFID chip of ten RFID chips 302-1 to 302-10 wirelessly.

As shown in FIG. 3, the switch 304 connects the RFID chip 302-1 to the RFID antenna 306. If the RFID reader 310 outputs a radio frequency signal for checking an inspected state of the gasometer 330 to the RFID antenna 306 periodically, the unique number of the RFID chip 302-1 is transmitted to the RFID reader 310 through the RFID antenna 306. The RFID reader 310 receives the unique number of the RFID chip 302-1 and transmits to a controller 320.

The controller 320 has information that each unique number of the RFID chips 302-1 to 302-10 means the specific largest digit of four figures. The information can be obtained through the naming center 130 and the database server 140. The controller 320 can recognize the largest digit of four figures, e.g., 0, of the gasometer 330 by checking the unique number of the transmitted RFID chip 302-1.

Other RFID sensors, i.e., the second RFID sensor 300b, the third RFID sensor 300c and the fourth RFID sensor 300d operate in the same way with the first RFID sensor 300a, and the controller 320 can recognize the second, the third and the fourth digit of four figures of the gasometer 310 from the RFID sensors respectively.

The RFID reader 310 can be configured to be portable by a meterman. The meterman visits each home without entering their houses, approaches only to the position that the radio frequency of the RFID reader 310 can be transmitted and received, and collects information about the inspected state of the gasometer 310.

It will be apparent to those skilled in the art that the prescribed technology concept and scope are applicable to various meters, but not exclusively to the gasometer.

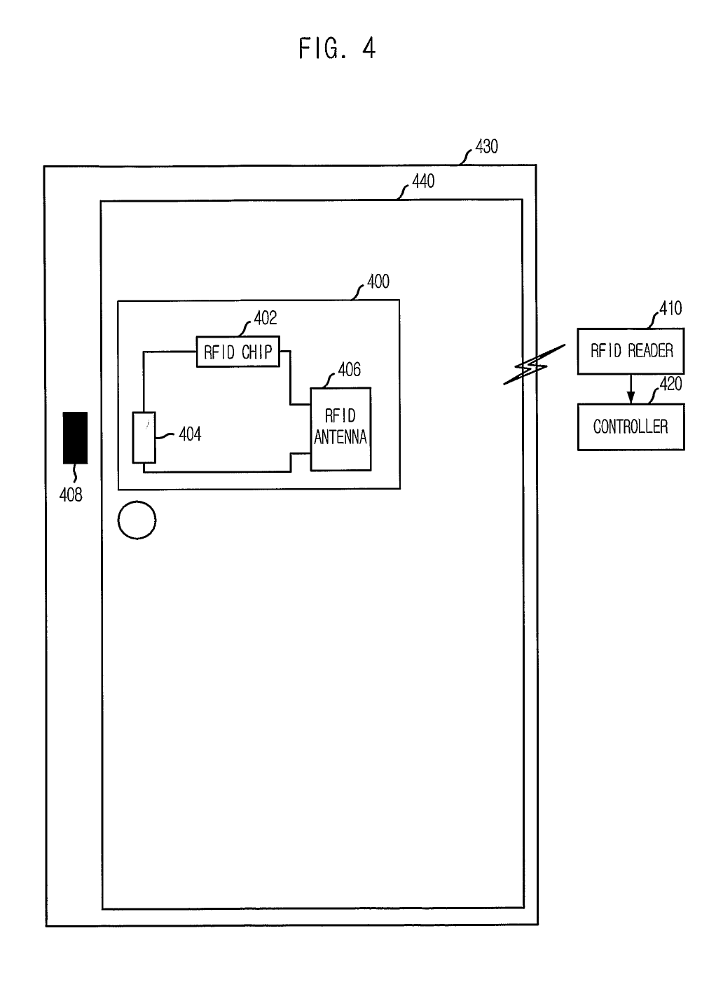

FIG. 4 is a block diagram showing a ubiquitous sensor network system for monitoring a used state of a door in accordance with one embodiment of the present invention.

An RFID sensor 400 senses a used state of a door 440. The RFID sensor 400 includes one RFID chip 402, a selection unit 404 and an RFID antenna 406. The selection unit 404 comprises a magnetic sensor, e.g., a reed switch, sensing the presence of a magnetic force of a magnetic body 408 in a doorframe 430. When the door 440 is closed, the reed switch 404 senses the magnetic force of a magnetic body 408 and connects the RFID chip 402 to the RFID antenna 406. When the door is open, the reed switch 404 senses a physical variance through the magnetic force of the magnetic body 408 and disconnects the RFID chip 402 from the RFID antenna 406. The RFID reader 410 outputs a radio frequency signal for checking a used state of the door 440 to the RFID antenna 406 periodically. If the RFID chip 402 is connected to the RFID antenna 406, a unique number of the RFID chip 402 is transmitted to the RFID reader 410 through the RFID antenna 406.

A controller 420 has information that the unique number of the RFID chip 402 means that the door 440 is closed. The information can be obtained through the naming center 130 and the database server 140. The controller 420 can recognize the door 440 is in a closed state by checking the unique number of the RFID chip 402. Also, if the unique number of the RFID chip 402 is not transmitted through the RFID antenna 406, the controller 420 can recognize the door 440 is in an open state. The reed switch can be operated oppositely. That is, in case that the door is closed, the reed switch disconnects the RFID chip 402 from the RFID antenna 406 and in case that the door is open, the RFID chip 402 can be connected to the RFID antenna 406. In such a case, the controller 420 can recognize the door 440 is in an open state by checking the unique number of the transmitted RFID chip 402.

In FIG. 4, one RFID chip is used for sensing whether the door is open or closed, but it is possible that two RFID chips are used for sensing whether the door is open or closed. Also, it will be apparent to those skilled in the art that the RFID sensor using the magnetic sensor can be applied to sense whether various doors including a safe door are open or closed. If the sensors for sensing the used state of the door are set up in many places of a house, a user can see the used states of a door of each room and a safe door in real-time.

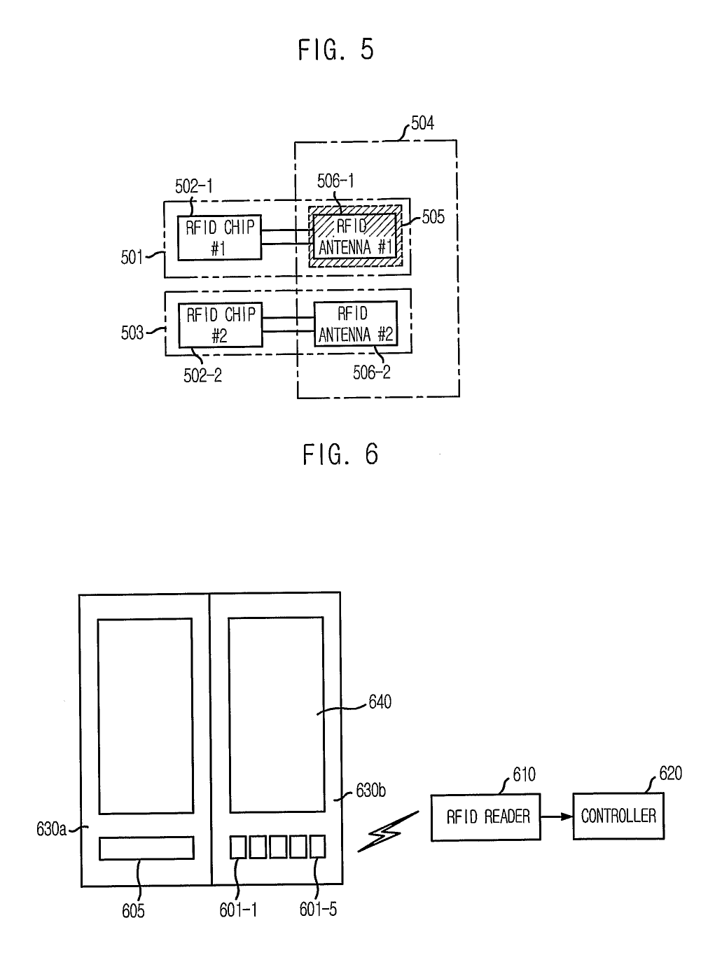

FIG. 5 is a block diagram showing an RFID sensor in accordance with one embodiment of the present invention. FIG. 1 shows the configuration that the selection unit 104 connects the RFID chips 102 to one RFID antenna 106 selectively by the physical variance of the monitored object such as a meter. In FIG. 5, a selection unit 504 selects one of a first RFID tag 501 and a second RFID tag 503 with a blackout plate 505 by the physical variance of the monitored object. The blackout plate 505 shields antennas 506-1 and 506-2 selectively. In FIG. 5, the blackout plate 505 shields the antenna 506-1 of the first RFID tag 501. Therefore, the unique number of the second RFID tag 503 is transmitted to the RFID reader(not shown).

FIG. 6 is a diagram showing a ubiquitous sensor network system for sensing a used state of a window.

A copper plate 605 is set up for shielding antennas of RFID tags 601 in a window frame 630a and a plurality of RFID tag 601 are set up in a window frame 630b. If the RFID reader 610 outputs a signal for checking a used state of a window 640 to the RFID tags 601 periodically, the unique numbers of the RFID tags 601 are transmitted to the RFID reader 610. The RFID reader 610 receives each unique number and transmits the number to a controller 620. The controller 620 checks a meaning of a unique number of the received RFID tag 601-1 to 601-5 on the basis of the information obtained from the naming center 130 and the database server 140 and recognizes the used state of the window 640.

If the signals of all the RFID tags 601 are shielded because the door is wide open, the controller 620 cannot receive any unique number from the tags 601, thereby recognizing that the window 640 is wide open. If there are many RFID tags 601, the controller 620 can recognize a degree of openness of the window 640 according to the number of the shielded RFID tag 601.

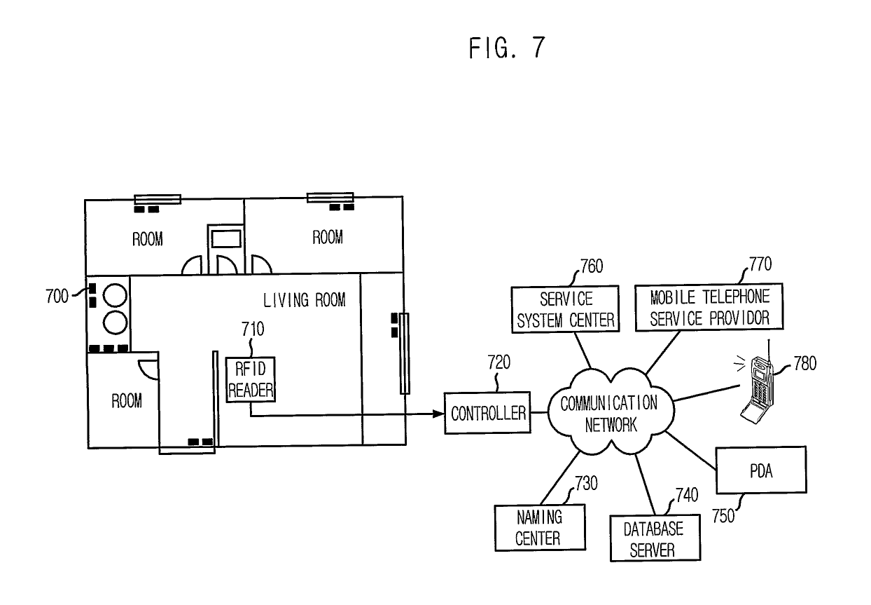

FIG. 7 is a schematic block diagram showing a ubiquitous sensor network system in accordance with one embodiment of the present invention, and a black box in the figure indicates a plurality of RFID sensors which are set up in a proper position of home. An RFID reader 710 is set up in a proper position of each home and receives a radio frequency signal from an RFID sensor 700 for an inspection and crime prevention. The reader 710 transmits the collected unique number of each RFID chip to the controller 720. In FIG. 7, the controller 720 is illustrated as being positioned in the outside of home for convenience of explanation, but it is also possible for the controller 720 to be positioned in the inside of home. Also, the controller 720 can be configured to include an RFID reader 710 as one module.

The controller 720 can be a personal computer or a Set-Top Box which is set up at home in a conventional remote inspection system or a crime prevention system. The controller 720 checks the unique number of each RFID chip transmitted from the RFID reader 710 on the basis of the information obtained from a naming center 730 and a database server 740, and recognizes a state of an inspection and crime prevention. The controller 720 transmits the recognized state of the inspection and the crime prevention to a service system center 760 or a mobile telephone service provider 770 through an external telecommunication network.

The service system center 760, e.g., a crime prevention service company, an inspection center, a police office, can check a state of inspection or crime prevention of the home on the basis of the information provided by the controller 720. In case of emergency, through the information, the mobile phone service provider 770 can provide various services including the service of transmitting a warning message to the mobile telecommunication terminal 780 of the home.

Also, the controller 720 embedding a Bluetooth module can transmit a warning message directly to a PDA 750. Also, the controller 720 can show a state information of a present inspection or crime prevention of home on a display device (not shown) prepared properly in a place such as a front door.

The present application contains object matter related to Korean patent application No. 2004-23882, filed in the Korean Intellectual Property Office on Apr. 7, 2004, the entire contents of which is incorporated herein by reference.

It will be apparent to those skilled in the art that various changes and modifications may be made without departing from the scope of the invention.

For example, it is possible to set up a pressure RFID sensor using a membrane switch instead of a magnetic RFID sensor like a tile in every unit area of a pressure member. In this case, it is possible to recognize whether each unit area is pressurized or not. Therefore, the present invention can be applied to a crime prevention or security field. For example, if a RFID sensor senses that a window is open and a tile under the window is pressurized, there is a possibility of a thief invasion. If the order in which the unit area is pressurized is checked, a moving route of the invader can be also tracked.

While the present invention has been described with respect to certain preferred embodiments, it will be apparent that the invention is not limited to the embodiments, various changes and modifications may be made without departing from the scope of the invention as defined in the following claims.

### INDUSTRIAL APPLICABILITY

The present invention can be applied to a sensor and a ubiquitous sensor network system field. Also, it can be applied to the fields of a remote inspection, a crime prevention, a security and a home automation.

What is claimed is:

1. A ubiquitous sensor network system, comprising:
a Radio Frequency Identification (RFID) sensor for extracting a unique number of at least one RFID chip chosen according to a used state of a monitored object among at least one RFID chip set up on a monitored object according to the number of usable states of the monitored object; and
a controlling unit for receiving the unique number from the RFID sensor and recognizing the used state of the monitored object on the basis of meaning information of the unique number.

2. The ubiquitous sensor network system as recited in claim 1, wherein the controlling unit includes:
an RFID reader for transmitting a radio frequency signal for sensing a signal to the RFID sensor at a predetermined interval and receiving the unique number; and
a controller for receiving the unique number from the RFID reader and recognizing the used state of the monitored object.

3. The ubiquitous sensor network system as recited in claim 1, further including:
a naming center for storing manufacturer information of the unique number of the RFID chip; and
a database server for storing the meaning information of the unique number for each manufacturer.

4. The ubiquitous sensor network system as recited in claim 3, wherein the controlling unit requests manufacturer information of the unique number of the chosen RFID chip to the naming center and receives the manufacturer information, then requests the meaning information of the unique number of the chosen RFID chip to the database server on the basis of the received manufacturer information and receives the meaning information; and
the controlling unit recognizes the used state of the monitored object on the basis of the received meaning information.

5. The ubiquitous sensor network system as recited in claim 4, wherein the received meaning information is stored in the controlling unit, and can be acquired from the controlling unit afterward.

6. The ubiquitous sensor network system as recited in claim 1, wherein the RFID sensor includes:
at least one RFID chip set up on the monitored object according to the number of usable states of the monitored object;
an RFID antenna for receiving the radio frequency signal from the controlling unit and transmitting the unique number to the controlling unit; and
a selection unit for connecting one of the RFID chips to the RFID antenna by a physical variance of the monitored object.

7. The ubiquitous sensor network system as recited in claim 6, wherein if the number of usable states of the monitored object is n, where n=2, 3, 4 . . . , the number of the RFID chips is n.

8. The ubiquitous sensor network system as recited in claim 6, wherein if the number of usable states of the monitored object is 2, the number of the RFID chip is 1 or 2.

9. The ubiquitous sensor network system as recited in claim 8, wherein in case that the used state of a gas valve is monitored by two RFID chips;
by the selection unit comprising a rotary switch,
if a first RFID chip is connected to the RFID antenna, the controlling unit recognizes as a closed state by a unique number of the first RFID chip; and
if a second RFID chip is connected to an RFID antenna, the controlling unit recognizes as an open state by a unique number of the second RFID chip.

10. The ubiquitous sensor network system as recited in claim 8, wherein the used state of a gas valve is monitored by one RFID chip;
by the selection unit comprising a rotary switch,
if the RFID chip is connected to the RFID antenna, the controlling unit recognizes as one of a closed state and an open state by the unique number of the first RFID chip; and
if the RFID chip is not connected to the RFID antenna, the controlling unit recognizes as the opposite state.

11. The ubiquitous sensor network system as recited in claim 8, wherein in case that the used state of a door is monitored by two RFID chips;
by the selection unit comprising a magnetic sensor,
if a first RFID chip is connected to the RFID antenna, the controlling unit recognizes as a closed state by the unique number of the first RFID chip; and
if the second RFID chip is connected to the RFID antenna, the controlling unit recognizes as an open state by the unique number of the second RFID chip.

12. The ubiquitous sensor network system as recited in claim 8, wherein in case that the used state of a door is monitored by one RFID chip;
by the selection unit comprising a magnetic sensor,
if the RFID chip is connected to the RFID antenna, the controlling unit recognizes as one of a closed state and an open state by the unique number of the first RFID chip; and
if the first RFID chip is not connected to the RFID antenna, the controlling unit recognizes as the opposite state.

13. The ubiquitous sensor network system as recited in claim 8, wherein in case that whether a member is pressurized or not is monitored by two RFID chips;
by the selection unit comprising a pressure sensor,
if the first RFID chip is connected to the RFID antenna, the controlling unit recognizes as a pressurized state by the unique number of the first RFID chip; and
if the second RFID chip is connected to the RFID antenna, the controlling unit recognizes as an unpressurized state by the unique number of the second RFID chip.

14. The ubiquitous sensor network system as recited in claim 8, wherein in case that whether a member is pressurized or not is monitored by one RFID chip;
by the selection unit comprising a pressure sensor,
if the first RFID chip is connected to the RFID antenna, the controlling unit recognizes as one of a pressurized state and an unpressurized state by the unique number of the first RFID chip; and
if the first RFID chip is not connected to the RFID antenna, the controlling unit recognizes as the opposite state.

15. The ubiquitous sensor network system as recited in claim 6, wherein the RFID chips are set up according to the number of each figure of each rotary number indicator of a meter, and the selection unit comprises a rotary switch working by a physical operation power caused by the rotation of the rotary number indicator.

16. The ubiquitous sensor network system as recited in claim 15, wherein the controlling unit recognizes a figure of each rotary number indicator by the unique number of the chosen RFID chip.

17. The ubiquitous sensor network system as recited in claim 1, wherein the RFID sensor includes:
a plurality of RFID chips set up on the monitored object according to the number of usable states of the monitored object;
a plurality of RFID antennas of the same number with the RFID chips, each one of the RFID antennas corresponding to one of the RFID chips respectively; and
a selection unit for connecting at least one of the RFID chips to the corresponding RFID antenna individually by the physical variance of the monitored object.

18. The ubiquitous sensor network system as recited in claim 1, wherein the RFID sensor includes:
at least one RFID chip set up on the monitored object according to the number of usable states of the monitored object;
at least one RFID antenna connected to the RFID chip respectively; and
a blackout plate for shielding the RFID antenna selectively according to the physical variance of the monitored object.

19. The ubiquitous sensor network system as recited in claim 18, wherein the RFID chip and the RFID antenna are set up in a first window frame and the blackout plate is set up in a second window frame.

20. The ubiquitous sensor network system as recited in claim 19, wherein the degree of openess is recognized according to the number of the shielded RFID antenna.

21. The ubiquitous sensor network system as recited in claim 1, wherein the RFID sensor is manufactured as one body with the monitored object.

22. The ubiquitous sensor network system as recited in claim 1, wherein the controlling unit transmits the used state information of the monitored object to the external service system center through a communication network.

23. The ubiquitous sensor network system as recited in claim 1, wherein the controlling unit transmits the used state information of the monitored object to the mobile phone service provider through a communication network.

24. The ubiquitous sensor network system as recited in claim 23, wherein the mobile phone service provider transmits a warning message to a user's mobile phone terminal on the basis of the used state information.

25. The ubiquitous sensor network system as recited in claim 1, wherein the controlling unit transmits the warning message directly to a user's terminal.

26. The ubiquitous sensor network system as recited in claim 1, wherein the controlling unit provides the state information through a display device set up in a specific position.

27. A Radio Frequency Identification (RFID) sensor, including:
at least one RFID chip set up on a monitored object according to the number of usable states of the monitored object;
an RFID antenna for receiving a radio frequency signal from a RFID reader; and
a selection unit for choosing one of the RFID chip and connecting the chosen RFID chip to the RFID antenna,
wherein the RFID antenna transmits the unique number of the chosen RFID chip to the RFID reader.

28. A Radio Frequency Identification (RFID) sensor, including:
a plurality of RFID chips set up on a monitored object according to the number of usable states of the monitored object;
a plurality of RFID antennas of the same number with the RFID chips, each one of the RFID antennas corresponding to one of the RFID chips respectively, the RFID antennas receiving a radio frequency signal from a RFID reader; and
a selection unit for choosing at least one of the RFID chips and connecting the chosen RFID chip to the corresponding RFID antenna respectively,
wherein the RFID antenna transmits the unique number of the chosen RFID chip to the RFID reader.

29. A Radio Frequency Identification (RFID) sensor that, including:
at least one RFID chip set up on a monitored object according to the number of usable states of the monitored object;
at least one RFID antenna receiving a radio frequency from an RFID reader and connected to the RFID chip respectively; and
a blackout plate for shielding the RFID antenna selectively,
wherein the RFID antenna, which is not shielded, transmits the unique number of the connected RFID chip to the RFID reader.
